(19) United States
(12) Patent Application Publication
(10) Pub. No.: US 2008/0214294 A1
(43) Pub. Date: Sep. 4, 2008

(54) Gaming Machine Capable Of Operating To Indicate The Number Of Bets, And Game Playing Method

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 12/040,363

(22) Filed: Feb. 29, 2008

(30) Foreign Application Priority Data
Mar. 1, 2007 (JP) JP2007-051823

(51) Int. Cl. A63F 13/00; A63F 9/24

(52) U.S. Cl. 463/25

(57) ABSTRACT

Sic-Bo is executed by placing a bet using a bet screen 70 displayed on a liquid crystal display 10. On the bet screen 70 is provided a bet-with-a-bonus button 201 in addition to an ordinary bet button 75. When the amount of bets is indicated using the bet-with-a-bonus button 201, a dice game which is separate from Sic-Bo is executed as a bonus game subsequent to Sic-Bo, and the player is awarded a bonus payout based on an outcome of the bonus game. The odds when the amount of bets is indicated using the bet-with-a-bonus button 201 is set to be lower than the odds indicated using only the ordinary bet button 75.

### CROSS-REFERENCE TO RELATED APPLICATIONS

This application is based upon and claims a priority from the prior Japanese Patent Application No. 2007-051823 filed on Mar. 1, 2007, the entire contents of which are incorporated herein by reference.

### BACKGROUND OF THE INVENTION

1. Field of the Invention

This disclosure relates to a gaming machine capable of operating to indicate the number of bets, and a game playing method.

2. Description of Related Art

Conventionally, with games in which a side bet game is executed together with a main game, an operation of indicating the number of bets for the side bet game has been performed separately from an operation of indicating the original number of bets for the main game. Additionally, with the side bet game, it has been determined whether or not to award a bonus payout to a player thereof according to a game outcome in the main game. Furthermore, the determination to award the bonus payout to the player in the side bet game was based on a condition that a low-probability outcome is realized in the main game, since the bonus payout is relatively high (see, for example, U.S. Pat. No. 6,789,801B2, No. 5,711,525 and. 6,874,786B2).

In the above manner, however, an opportunity for the player to be awarded the bonus payout in the side bet game is rare. Furthermore, in order to participate in the side bet game, it is necessary, as stated above, to take the trouble of indicating the number of bets for the side bet game, quite separately from indicating the original number of bets for the main game. Thus, there has been a trend that the player of the main game, who is discouraged by the above situation, will not willingly attempt to be awarded the bonus payout in the side bet game, and recedes from the side bet game.

### SUMMARY OF THE INVENTION

An object of the disclosure is to provide an unprecedented, novel gaming machine and game playing method by adjusting the main game and the bonus payout lottery through a one-time indication of the number of bets.

To achieve the object of the disclosure, there is provided a gaming machine, comprising: a display device for displaying three dice used in a main game; an operation unit for allowing a player to indicate the number of bets of one of a first type and a second type for any of a plurality of bet spots; a memory for storing the number of credits held by the player; and a processor programmed to execute the main game by executing processes of: when the number of bets of the first type is indicated by an operation on the operation unit, (a) displaying, upon completion of the player's performing the operation of indicating the number of bets using the operation unit, a new outcome of shaking the three dice on the display device; (b) determining whether or not the player side wins, based on a combination of numbers shown on the three dice which have been displayed on the display device; and (c) if it is determined that the player side wins, adding the number of credits calculated using a predefined odds to the number of credits in the memory and storing the sum, when, otherwise, the number of bets of the second type is indicated by an operation on the operation unit, (d) changing the odds to a lower value than the predefined odds and executing the main game; (e) randomly determining whether or not to award a bonus to the player; and (f) if it is determined to award the bonus to the player, adding the number of credits according to the bonus to the number of credits in the memory and storing the sum.

Furthermore, according to another aspect, there is provided a game playing method comprising, so as to make a main game proceed, the steps of: when a player indicates the number of bets of a first type for any of a plurality of bet spots, (a) getting, upon completion of the player's indicating the number of bets, a new outcome of shaking the three dice; (b) determining whether or not the player side wins, based on a combination of numbers shown on the three dice; and (c) if it is determined that the player side wins, the number of credits calculated using a predefined odds are awarded to the player; when, otherwise, the player indicates the number of bets of a second type for any of the bet spots, (d) changing the odds to a lower value than the predefined odds and executing the main game; (e) randomly determining whether or not to award a bonus to the player; and (f) if it is determined to award the bonus to the player, awarding the number of credits according to the bonus to the player.

### BRIEF DESCRIPTION OF THE DRAWINGS

FIG. 1 is an explanatory view showing a bet screen displayed on a liquid crystal display of a terminal according to a present embodiment;

FIG. 2 is an outline view of a dice gaming machine according to the present embodiment;

FIG. 3 is an outline view of the terminal according to the present embodiment;

FIG. 4 is a block diagram schematically showing a control system of the dice gaming machine according to the present embodiment;

FIG. 5 is a block diagram schematically showing a control system of the terminal according to the present embodiment;

FIG. 6 is an explanatory view showing a betting board displayed on a bet screen on the liquid crystal display of the terminal according to the present embodiment;

FIG. 7 is an explanatory view showing the bet screen displayed on the liquid crystal display of the terminal according to the present embodiment;

FIG. 8 is an explanatory view showing the betting board displayed on the bet screen on the liquid crystal display of the terminal according to the present embodiment;

FIG. 9 is an explanatory view showing the bet screen displayed on the liquid crystal display of the terminal according to the present embodiment;

FIG. 10 is an explanatory view showing the betting board displayed on the bet screen on the liquid crystal display of the terminal according to the present embodiment;

FIG. 11 is an explanatory view showing the bet screen displayed on the liquid crystal display of the terminal according to the present embodiment;

FIG. 12 is an explanatory view showing a main screen displayed on a front display according to the present embodiment;

FIG. 13 is a flow chart of a game processing program in the dice gaming machine according to the present embodiment;

FIG. 14 is a flow chart of a game processing program in the dice gaming machine according to the present embodiment;

FIG. 15 is an explanatory view showing the bet screen at a bonus game displayed on the liquid crystal display of the terminal according to the present embodiment;

FIG. 16 is an explanatory view showing the bet screen at the bonus game displayed on the liquid crystal display of the terminal according to the present embodiment;

FIG. 17 is a flow chart of a game processing program in the dice gaming machine according to the present embodiment;

FIG. 18 is a flow chart of a game processing program in the dice gaming machine according to the present embodiment;

FIG. 19 is a flow chart of a game processing program in the dice gaming machine according to the present embodiment;

FIG. 20 is a flow chart of a game processing program in the dice gaming machine according to the present embodiment;

FIG. 21 is a table showing the difference between an ordinary bet operation and a bet-with-a-bonus operation; and

FIG. 22 is a schematic view of an exemplary application of the present invention to a table game.

### DETAILED DESCRIPTION OF THE PREFERRED EMBODIMENTS

In the following, a multi-player dice gaming machine according to the present invention will be described in detail referring to the drawings based on an embodiment implemented on a dice gaming machine. Here, the dice gaming machine according to the present embodiment is one type of multi-player gaming machines comprising a plurality of terminals for accepting inputs from the players and executes Sic-Bo, which is a kind of dice games. Here, Sic-Bo is a game in which each player first bets a certain amount of chips on for a combination or a total score of three numbers shown on three dice, then the combination or the total score which the player bets are compared with the three numbers shown on the three dice shaken by a dealer to determine the win or loss.

If the three numbers shown on the three dice shaken by the dealer is the player's bet target, it is determined that the player has won the game, and a payout is made according to the amount of bets.

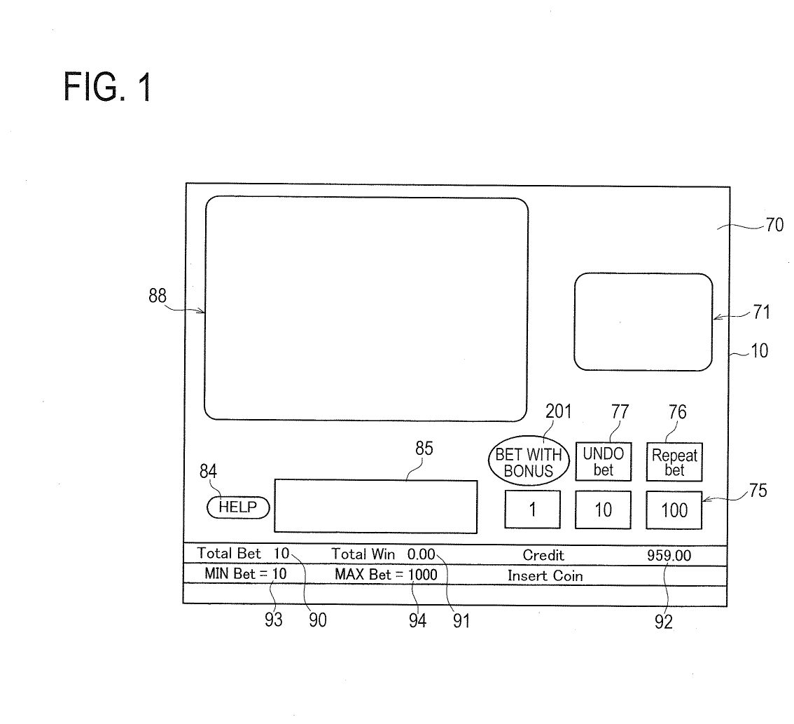

The dice gaming machine according to the present invention has, in addition to an ordinary bet button 75, a bet-with-a-bonus button 201, such as a bet screen particularly shown in FIG. 1. When the amount of bets is indicated by both the bet-with-a-bonus button 201 and the bet button 75, a dice game which is separate from Sic-Bo is executed as a bonus game subsequent to Sic-Bo, and a bonus payout is awarded to the player based on an outcome of the bonus game.

Here, odds are associated with a combination or a total score of three numbers shown on three dice shaken by a dealer, respectively. However, the odds when the amount of bets is indicated by both the bet-with-a-bonus button 201 and the bet button 75 is set to the odds (an ordinary value), when the amount of bets is indicated only by the bet button 75, of x0.7. In other words, the odds when the amount of bets is indicated by both the bet-with-a-bonus button 201 and the bet button 75 is set to be lower than the odds when the amount of bets is indicated only by the bet button 75.

For example, if the player bets on “4” which a total score of three numbers shown on three dice, the odds is 60 times when the amount of bets is indicated only by the bet button 75, otherwise, the odds is 42 times(=60 times x0.7) when the amount of bets is indicated by both the bet-with-a-bonus button 201 and the bet button 75, which is set be lower than the odds (60 times)when the amount of bets is indicated only by the bet button 75. If the player bets on “1” “1” “1” which is a combination of three numbers shown on three dice, the odds is 180 times when the amount of bets is indicated only by the bet button 75, otherwise, the odds is 126 times(=180 times x0.7) when the amount of bets is indicated by both the bet-with-a-bonus button 201 and the bet button 75, which is set be lower than the odds (180 times)when the amount of bets is indicated only by the bet button 75.

In the following, for simplicity of description, the phrase “when the amount of bets is indicated by both the bet-with-a-bonus button 201 and the bet button 75” may be occasionally expressed, for example, “when the amount of bets is indicated using the bet-with-a-bonus button 201”.

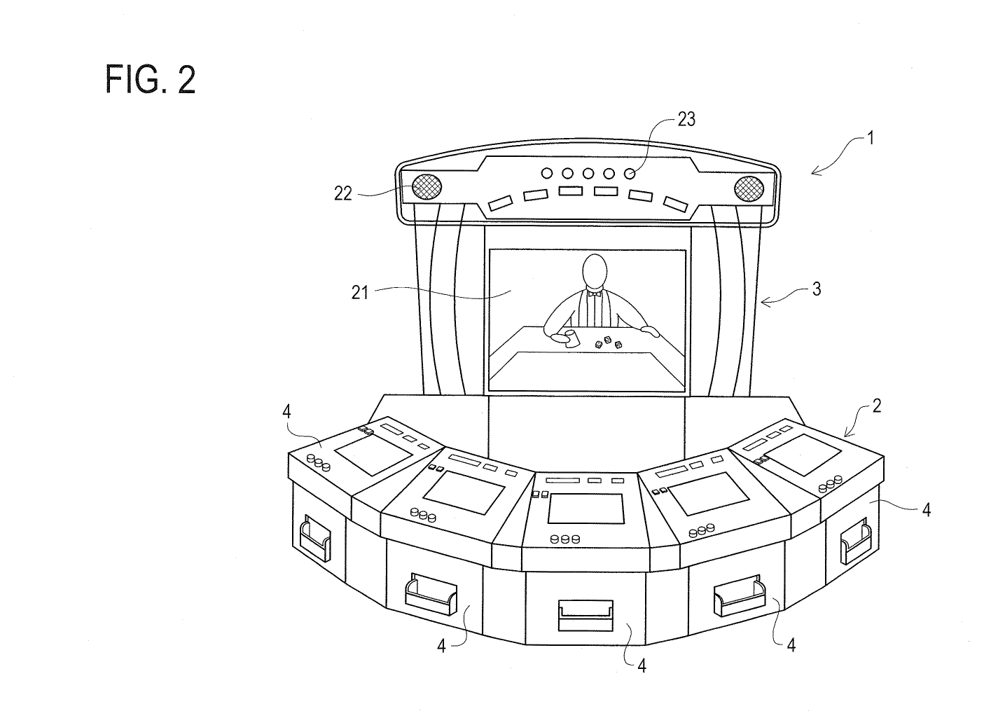

First, a structural overview of the dice gaming machine 1 according to the present embodiment will be described, referring to FIG. 2. FIG. 2 is an outline view of the dice gaming machine 1 according to the present embodiment.

The dice gaming machine 1 according to the present embodiment generally comprises a table unit 2 at which the player sits and plays the game, and a panel unit 3 provided behind the table unit 2 to display animation images of the dealer.

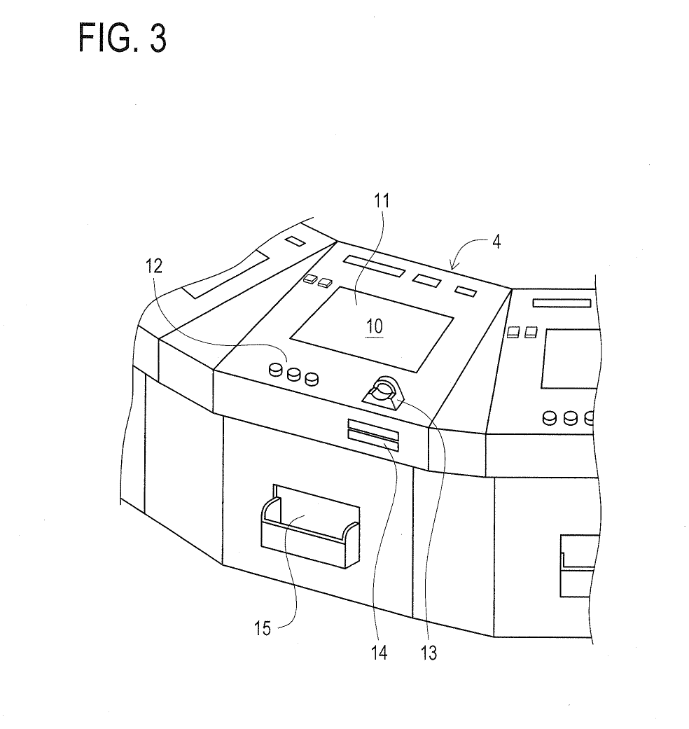

First, the table unit 2 will be described below. The table unit 2 has a plurality (five in FIG. 2) of terminals 4 referred to as satellites arranged in generally a fan-like manner. Here, FIG. 3 is an outline view of a terminal 4 according to the present embodiment.

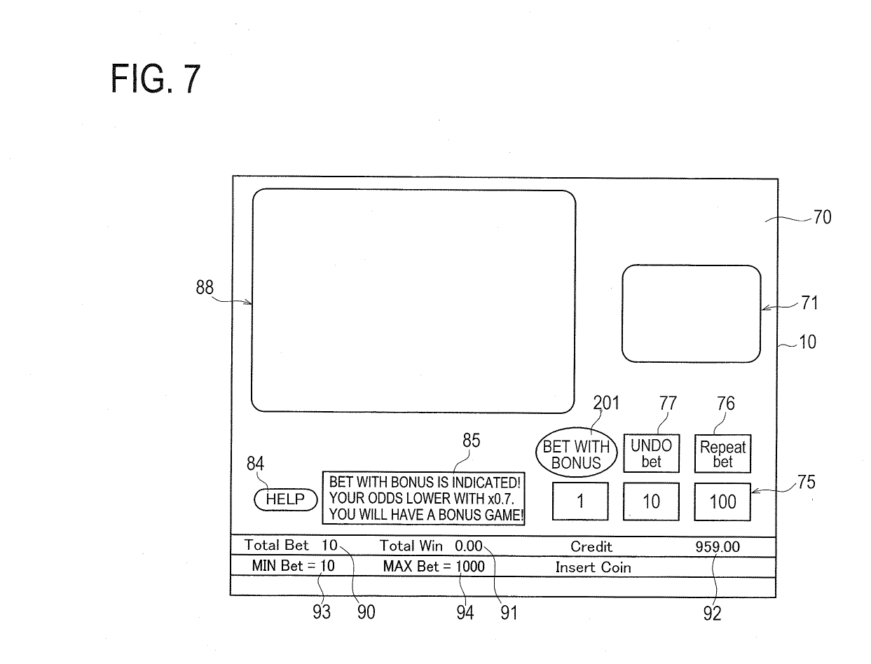

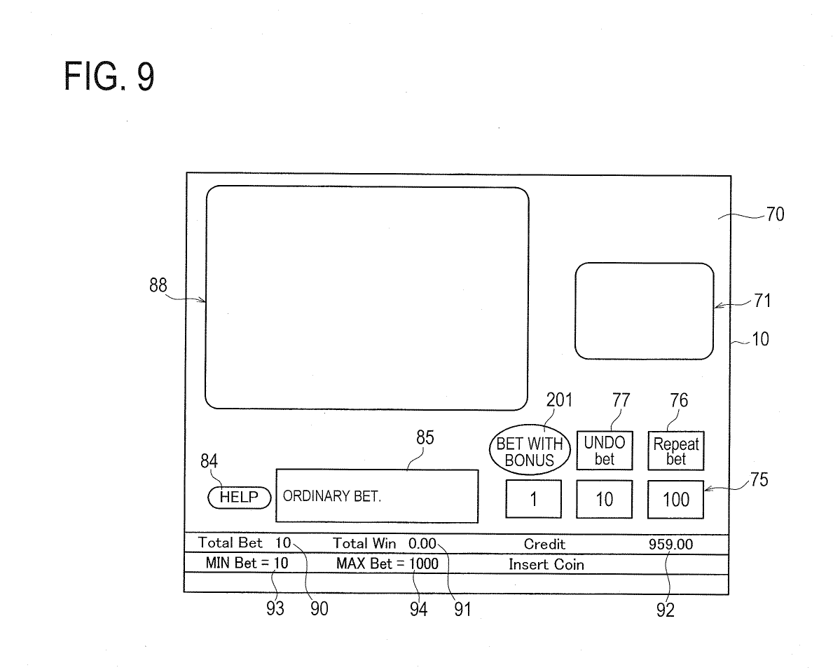

As shown in FIG. 3, the terminal 4 comprises a liquid crystal display 10 for displaying the bet screen (see FIGS. 7 and 9) described below and the game outcome or the like, a touch panel 11 provided on the front face of the liquid crystal display 10 and used for selecting the buttons which are displayed on the liquid crystal display 10 when selecting the bet target and indicating the amount of bets, an operation button 12 for performing a payout operation, a coin insertion slot 13 for inserting coins or medals, a bill insertion slot 14 for inserting bills, and a coin payout opening 15 for paying out, to the player, coins or medals corresponding to the accumulated credits when a payout operation is performed.

Referring to FIG. 2 again, the panel unit 3 comprises a front display 21 for displaying images of the dealer who is shaking the three dice or delivering the chips, and three numbers shown on the three dice being shaken or the like, speakers 22 provided on the upper part of the front display 21 for outputting music or sound effects along the progress of the game, and LEDs 23 which light up when a variety of effects are performed.

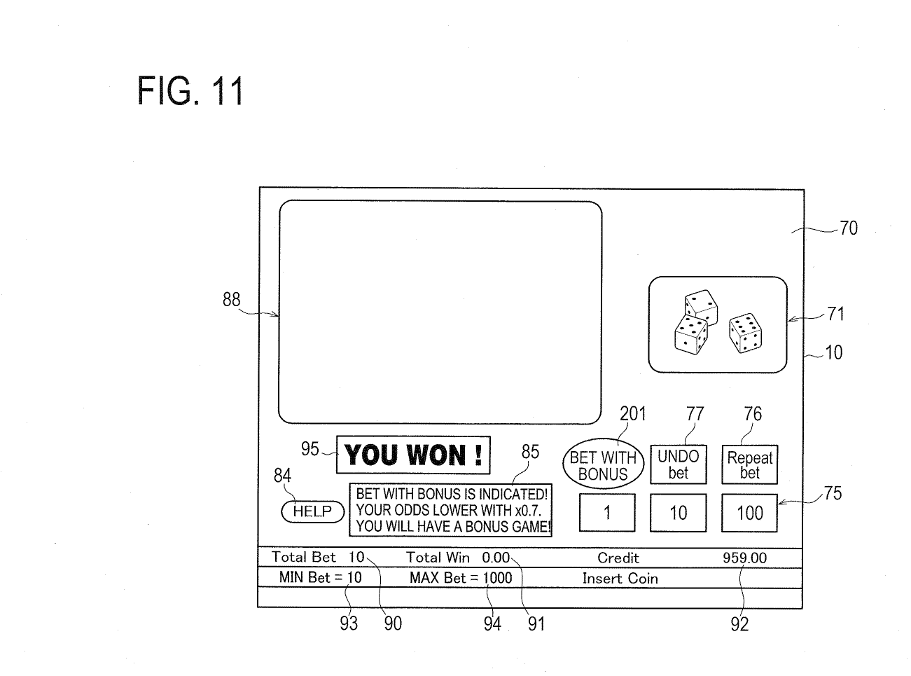

Here, each of the three dice used in the dice gaming machine 1 according to the present embodiment is a cube, marked on each of its six faces with a different numbers of “1”, “2”, “3”, “4”, “5”, and “6” (see FIG. 11 or the like ).

Next, a playing method of Sic-Bo in the dice gaming machine 1 arranged as above will be described, wherein the player who is going to play the game sits in front of the terminal 4 and places a desired amount of bets using the bet screen displayed on the liquid crystal display 10.

Subsequently, images of the three numbers shown on the three dice being shaken by the dealer are displayed on the front display 21 and each of the liquid crystal displays 10. Furthermore, if the player wins for the bet, credits multiplied the odds of the player's bet target by the amount of bets (number of credits) which has been placed is provided as an award at each of the terminals 4. However, as stated above, if the amount of bets is indicated by both the bet-with-a-bonus button 201 and the bet button 75, credits 0.7 times the number of credits multiplied the odds of the player's bet target by the amount of bets (number of credits) which has been placed is provided as an award. On the other hand, no award is provided if the player loses for the bet. Additionally, when the amount of bets is indicated by both the bet-with-a-bonus button 201 and the bet button 75 in particular, a dice game separate from Sic-Bo is executed as the bonus game subsequent to Sic-Bo, regardless of the player's winning, or losing in Sic-Bo, and a bonus payout is awarded to the player based on the outcome of the bonus game.

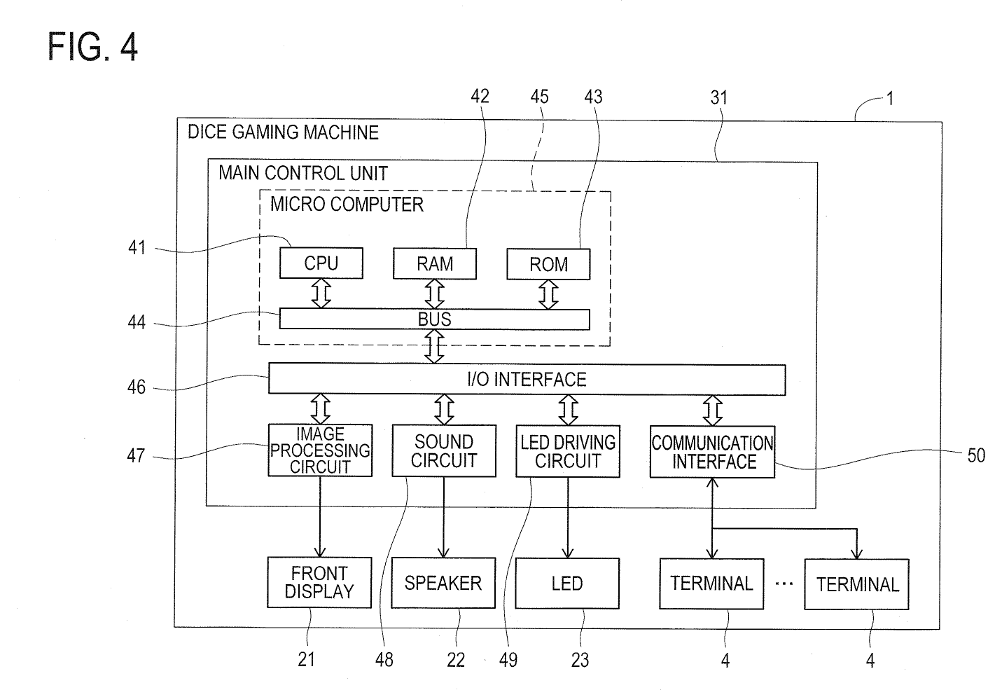

Next, the arrangement related to a control system of the dice gaming machine 1 will be described, referring to FIG. 4. FIG. 4 is a block diagram schematically showing the control system of the dice gaming machine 1 according to the present embodiment.

The dice gaming machine 1 according to the present embodiment comprises, as shown in FIG. 4, a main control unit 31, a plurality of terminals 4 connected to the main control unit 31, and a variety of peripheral devices.

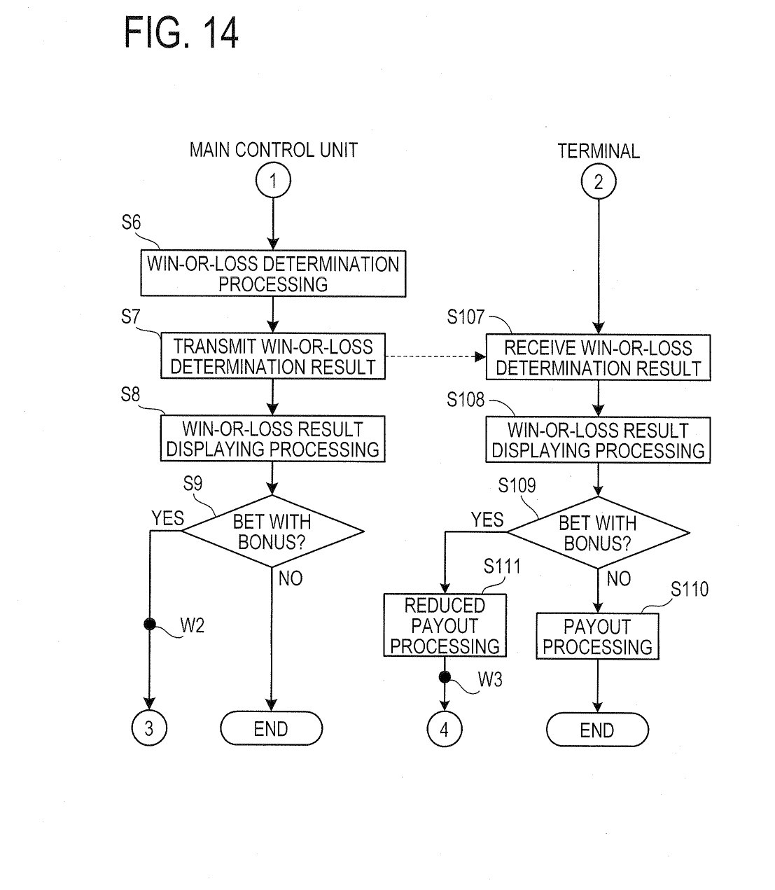

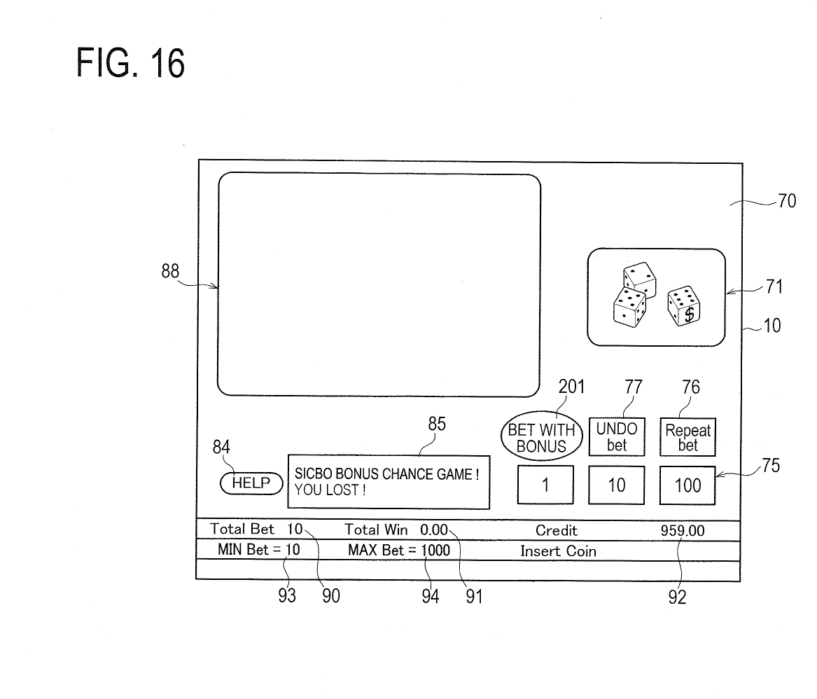

The main control unit 31 is generally composed of a micro-computer 45 as the kernel comprising a CPU 41, a RAM 42, a ROM 43 and a bus 44 for transferring data mutually between these elements. The ROM 43 stores a variety of programs, data tables or the like for executing necessary processes to control the dice gaming machine 1. The RAM 42 is a memory for temporarily storing a variety of data which have been operated in the CPU 41. Furthermore, the ROM 43 also stores image data of the three dice. Particularly, with the dice gaming machine 1 according to the present embodiment, a dice game which is separate from Sic-Bo may be executed as the bonus game subsequent to Sic-Bo as stated above, in which case the image data of the three dice used in the bonus game is also stored (see FIGS. 14 and 16).

In addition, the CPU 41 is connected, via an I/O interface 46, to an image processing circuit 47, a sound circuit 48, an LED driving circuit 49, and a communication interface 50.

The main control unit 31 receives the player's bet operation information related to the amount of bets from each of the terminals 4 and determines whether or not a condition is realized to start the game of Sic-Bo. Then, upon starting the game of Sic-Bo, the main control unit 31 assigns, based on a lottery result, the three numbers shown on the three dice to the result of the lottery, respectively (on the display screen, the three dice are shaken, respectively). As the result, the win or loss (either the player has won or lost) is determined based on a combination or a total score of the three numbers shown on the three dice are shaken, and the main control unit 31 transmits the result of determination to each of the terminals 4. Subsequently, each of the terminals 4 increases or decreases the accumulated credits according to the result of win or loss received from the main control unit 31.

Furthermore, the main control unit 31 identifies the terminal 4 at which the player's bet operation has been performed on both the bet-with-a-bonus button 201 and the bet button 75 according to the bet operation information received from each of the terminals 4. Regardless of the win or loss result of Sic-Bo, the main control unit 31, for the identified terminal 4, assigns, based on a lottery result, the three numbers, which “6” is exchanged with “$”, shown on the three dice to the result of the lottery, respectively (on the display screen, the three dice are shaken, respectively). As the result, the main control unit 31 determines the win or loss of bonus based on whether or not the combination of the three numbers shown on the three dice is a winning combination of “$” “$” “$”, and transmits the determination result to the terminal 4. Subsequently, based on the result of win or loss for the bonus which is received from the main control unit 31, the terminal 4 increases the accumulated credits by amount of the bonus payout, only when the combination of the three numbers shown on the three dice is a winning combination of “$” “$” “$”.

In addition, the main control unit 31 also outputs image signals to be displayed on the front display 21, and controls driving of the speakers 22 and the LEDs 23.

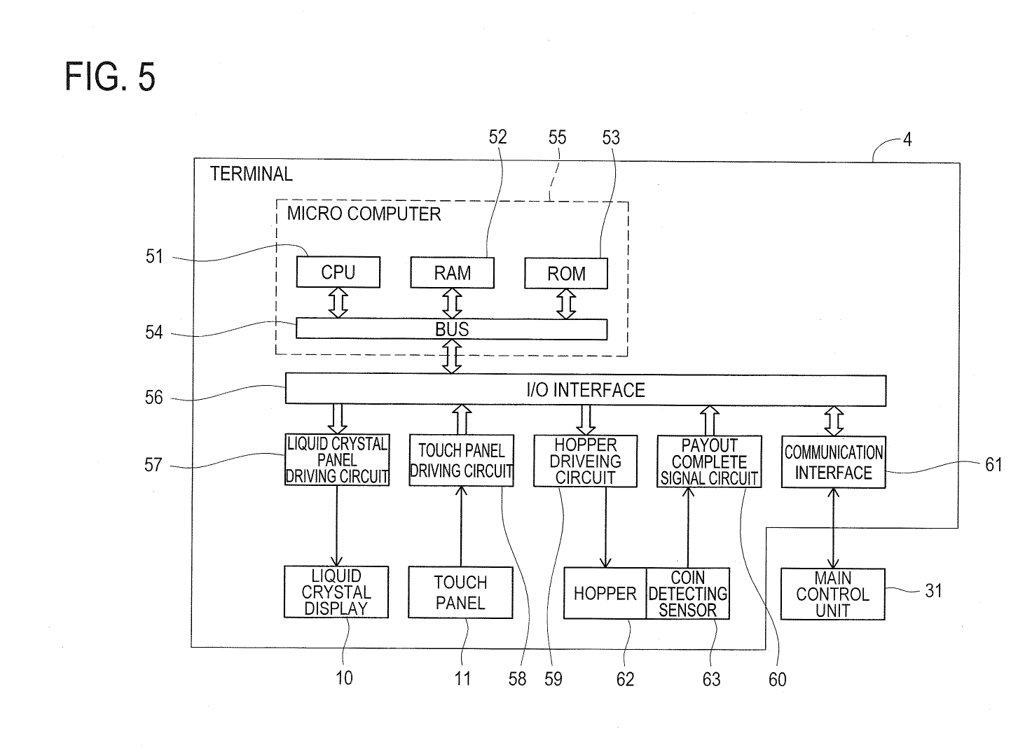

Next, the arrangement related to a control system of the terminal 4 will be described, referring to FIG. 5. FIG. 5 is a block diagram schematically showing the control system of the terminal 4 according to the present embodiment.

The terminal 4 according to the present embodiment is generally composed of a microcomputer 55 as the kernel comprising a CPU 51, a RAM 52, a ROM 53 and a bus 54 for transferring data mutually between these elements, as shown in FIG. 5. ROM 43 includes a variety of programs, data tables or the like stored therein for executing necessary processes to control the terminal 4. The RAM 52 is a memory for temporarily storing a variety of data which have been operated in the CPU 51, such as the number of credits (that is, the number of credits held by the player at the terminal 4) currently accumulated on the terminal 4, the bet target on which the player placed a bet, the bet type (whether or not the bet-with-a-bonus button 201 has been used), the amount of bets (number of credits) which has been placed on the bet target or the like.

In addition, the CPU 51 is connected, via an I/O interface 56, to a liquid crystal panel driving circuit 57, a touch panel driving circuit 58, a hopper driving circuit 59, a payout complete signal circuit 60, and a communication interface 61. Furthermore, a liquid crystal display 10 is connected to the liquid crystal panel driving circuit 57, a touch panel 11 is connected to the touch panel driving circuit 58, a hopper 62 is connected to the hopper driving circuit 59, and a coin detecting sensor 63 is connected to the payout complete signal circuit 60, respectively. Additionally, the main control unit 31 is connected to the communication interface 61.

Based on operation information which is output from the touch panel 11, the CPU 51 calculates the amount of bets (number of credits) placed by the player and identifies the player's bet target, then, together with information about whether or not the bet operation has been performed using the bet-with-a-bonus button 201 (type of bet), stores them into the RAM 52 and transmits them to the main control unit 31. Furthermore, the CPU 51 increases or decreases the accumulated credits according to the win or loss transmitted from the main control unit 31. Additionally, when the player has performed the bet operation using the bet-with-a-bonus button 201, the CPU 51 increases the accumulated credits according to the win or loss for the bonus transmitted from the main control unit 31.

In addition, the CPU 51 also outputs image signals to be displayed on the liquid crystal display 10, and controls payout of coins from the coin payout opening 15 by the hopper 62 and the coin detecting sensor 63.

Next, a bet screen 70 which is displayed on the liquid crystal display 10 of the terminal 4 when Sic-Bo is played on the dice gaming machine 1 according to the present embodiment will be described, referring to FIG. 1, FIG. 7, FIG. 9 and FIG. 11. FIG. 1, FIG. 7, FIG. 9 and FIG. 11 are diagrams showing the bet screen 70 displayed on the liquid crystal display 10 of the terminal 4. Here, with the dice gaming machine 1 according to the present embodiment, the player uses the bet screen 70 and the touch panel 11 to perform a bet operation of placing a certain amount of credits. With regard to this, the bet operation includes an ordinary bet operation which is performed only on the bet button 75 without using the bet-with-a-bonus button 201, and a bet-with-a-bonus operation which is performed on both the bet-with-a-bonus button 201 and the bet button 75.

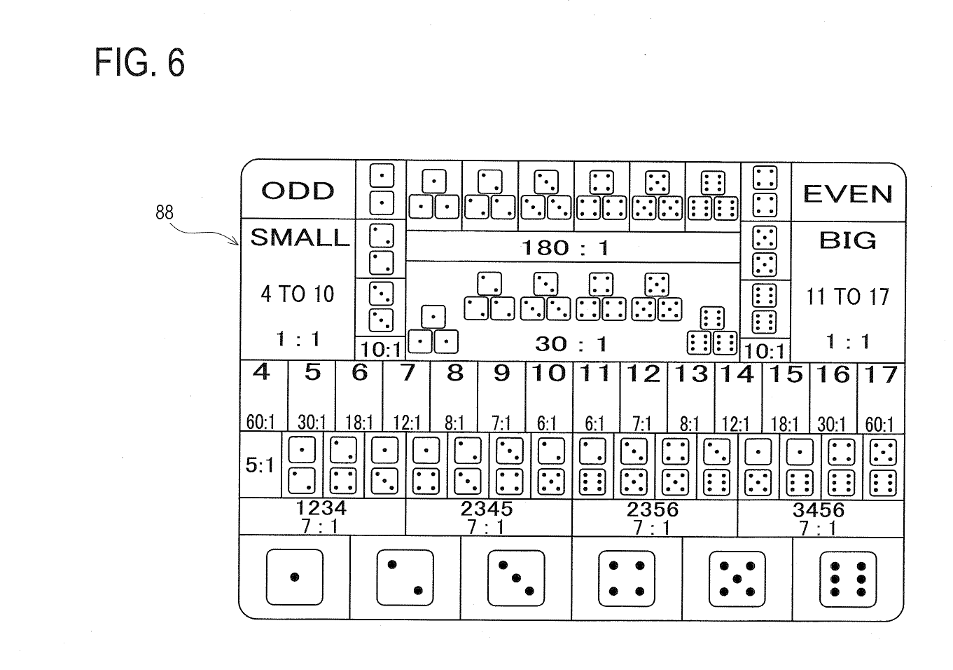

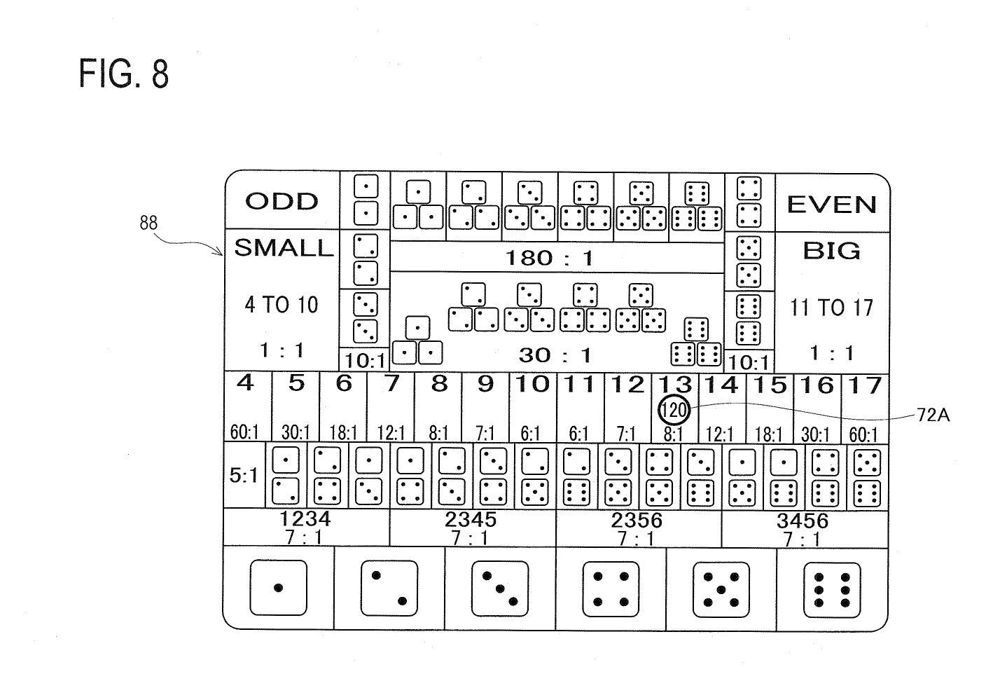

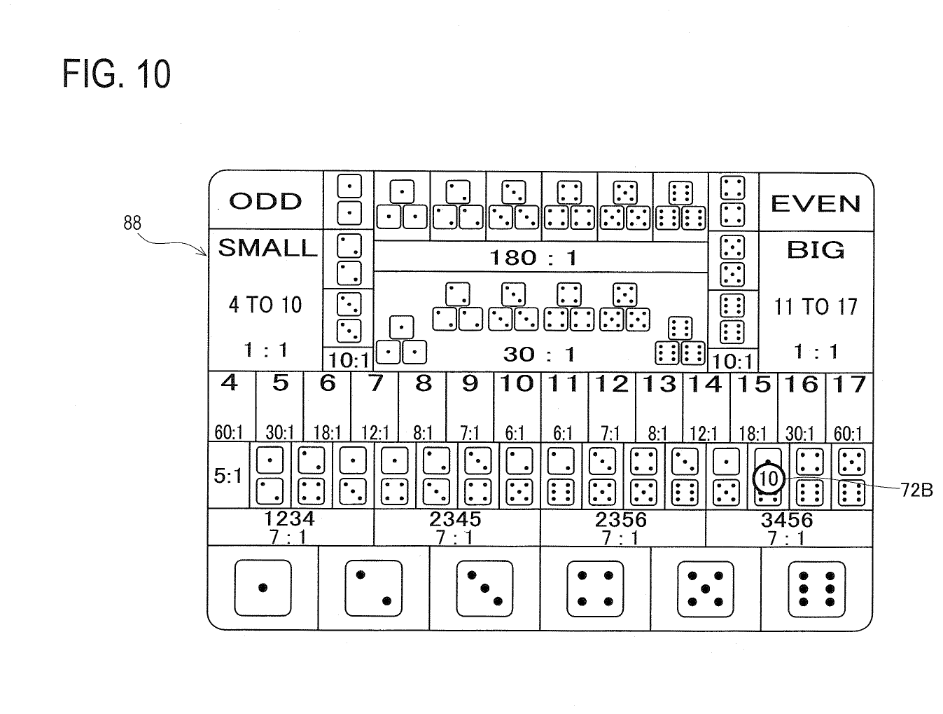

As shown in FIG. 1, FIG. 7, FIG. 9 and FIG. 11, the bet screen 70 comprises a dice display area 71 for displaying the three dice are shaken by the dealer, a chip display area 88 for displaying a image 72 (see FIGS. 8 and 10) of the chips which have been bet and a betting board (see FIG. 6), and an information display area for displaying a variety of operation buttons and information of the player.

Here, the image 72 of chips (see FIGS. 8 and 10) includes an image 72A of chips (see FIG. 8) which is displayed for a bet-with-a-bonus operation performed on both the bet-with-a-bonus button 201 and the bet button 75, and an image 72B of chips (see FIG. 10) which is displayed for an ordinary bet operation performed only on the bet button 75 without using the bet-with-a-bonus button 201. With regard to this, both images 72A and 72B of chips are distinctly displayed using different colors or the like, although not shown.

Here, the chip display area 88 displays the betting board shown in FIG. 6, FIG. 8 and FIG. 10. The betting board is divided to each area corresponding to a combination or a total score of three numbers shown on three dice. Each of the areas displays the odds when the amount of bets is indicated only by the bet button 75. The player then determines any of combinations or total scores of three numbers shown on three dice to the player's bet target, by touching any of areas on the betting board. The terminal 4 transmits the determined player's bet target to the main control unit 31.

The chip display area 88 displays the image 72 of chips corresponding to the amount of bets placed by the player (for example, chips corresponding to 120 credits are bet in FIG. 8 and chips corresponding to 10 credits are bet in FIG. 10). The player then selects the amount of bets using the bet button 75, determines the amount of bets by touching the chip display area 88. The terminal 4 transmits the determined amount of bets to the main control unit 31.

In addition, a plurality of the bet buttons 75 (three in the present embodiment, i.e., “one credit”, “10 credits”, and “100 credits”) are provided on the lower right hand side of the chip display area 88. Then, the player can select the amount of bets to be placed in the current game by touching the bet button 75.

Additionally, the bet-with-a-bonus button 201 is provided above the bet button 75. The player can indicate the amount of bets using the bet button 75 as a bet-with-a-bonus operation by touching the bet-with-a-bonus button 201 once.

However, if the amount of bets is indicated by using only the bet button 75 without touching the bet-with-a-bonus button 201, the operation turns out to be an ordinary bet operation.

Furthermore, a Repeat bet button 76 and an UNDO bet button 77 are provided above the bet button 75. The player can place a bet which is the same amount of bets as the previous game by touching the Repeat bet button 76. In addition, a bet operation performed once can be canceled by touching the UNDO bet button 77. Furthermore, a bet-with-a-bonus operation can be canceled by touching the UNDO bet button 77.

In addition, a HELP button 84 is provided on the lower side of the chip display area 88. The HELP button 84 is a button to be touched when displaying operation instructions of the dice gaming machine 1 on the liquid crystal display 10. Additionally, a message area 85 for displaying messages that support the progress of game is provided on the right hand side of the HELP button 84.

On the message area 85, messages such as “BET WITH BONUS IS INDICATED! YOUR ODDS LOWER WITH x0.7. YOU WILL HAVE A BONUS GAME!” are displayed, as shown in FIG. 7 or 11 while a bet-with-a-bonus operation is being performed. While, on the other hand, an ordinary bet operation is being performed, a message such as “ORDINARY BET.” is displayed, as shown in FIG. 9.

At the lower part of the bet screen 70, a bet amount display area 90 for displaying the amount of bets currently placed by the player, an acquisition amount display area 91 for displaying the amount provided to the player as an award in the game, a held credit display area 92 for displaying the number of credits currently held by the player, a lower-limit-of-bet-amount display area 93 displaying the lower limit of the amount of bets that can be placed by the player, and an upper-limit-of-bet-amount display area 94 displaying the upper limit of the amount of bets that can be placed by the player are provided.

Additionally, as shown in FIG. 11, a win-or-loss display area 95 displaying whether or not the player wins for the bet is provided on the lower side of the chip display area 88. Here, if the player wins for the bet, a character string “YOU WON!” is displayed on the win-or-loss display area 95. Furthermore, a character string “YOU LOST!” is displayed on the win-or-loss display area 95 when the player loses for the bet.

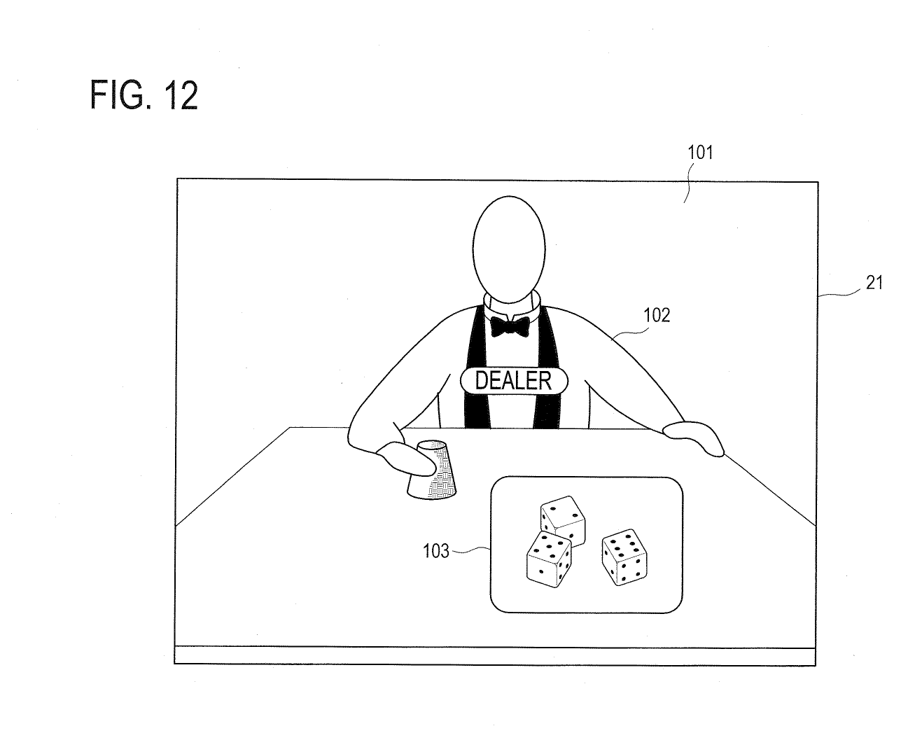

Next, a main screen 101 displayed on the front display 21 will be described referring to FIG. 12, when playing Sic-Bo in the dice gaming machine 1 according to the present embodiment.

FIG. 12 is a diagram showing the main screen 101 displayed on the front display 21. Here, with the dice gaming machine 1 according to the present embodiment, an image 102 of the dealer animated to perform shaking of the three dices along the progress of the game is displayed on the main screen 101 in order to improve the sense of reality of the game.

An enlarged image 103 of the three dice, which are shaken by the dealer, is displayed generally in the middle of the main screen 101.

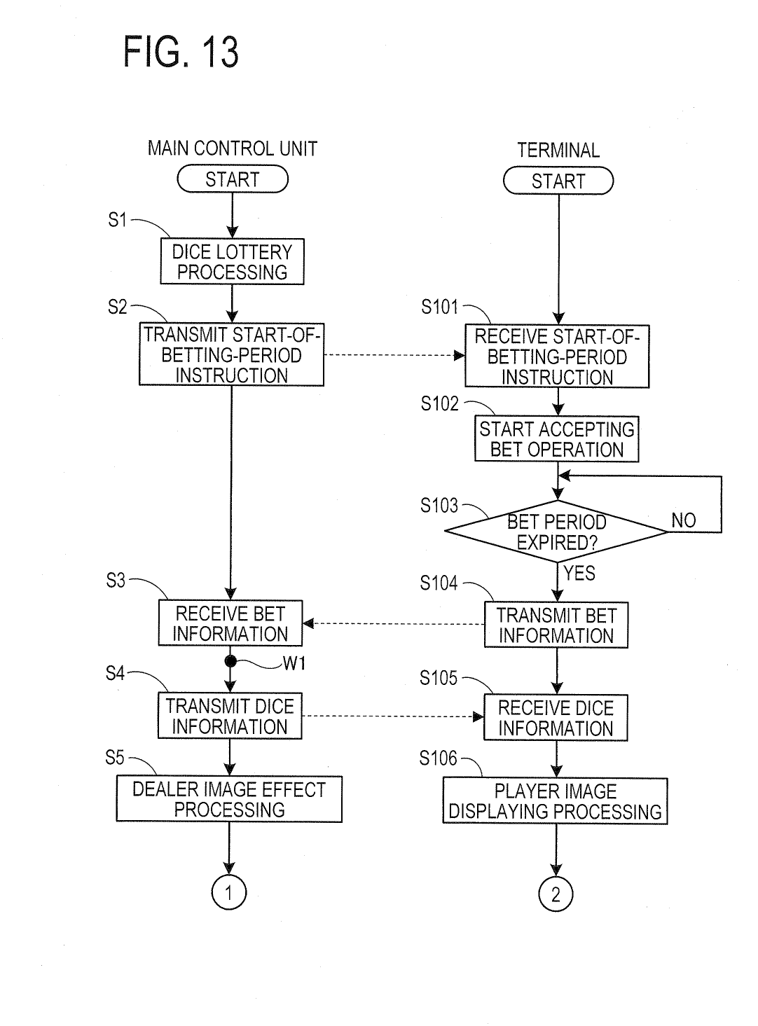

Next, a game processing program executed by the CPU 41 of the main control unit 31 and a game processing program at the terminal side executed by the CPU 51 of the terminal 4, respectively in the dice gaming machine 1 according to the present embodiment, will be described, referring to FIGS. 13 and 14. Here, respective programs shown as a flow chart in FIGS. 13 and 14 are stored in the RAM 42 or the ROM 43 provided in the main control unit 31, or the RAM 52 or the ROM 53 provided in the terminal 4, and are executed by the CPU 41 or the CPU 51.

First, the game processing program executed by the main control unit 31 will be described, referring to FIGS. 13 and 14. In step (abbreviated to S hereafter) 1, the CPU 41 executes a dice lottery processing to draw the three numbers shown on the three dice. Specifically, a number within the range of 1 to 6 is associated with each one of cube's faces composing one of the dice to be used in the game. Then, one of number within the range of 1 to 6 is drawn. This drawing is executed about each die respectively. A combination and a total score of three numbers shown on the three dice are determined by a combination of the drawn numbers.

Subsequently, in S2, the CPU 41 transmits, to each of the terminals 4, an instruction to start a betting period for accepting the player's bet operation.

Next, in S3, the CPU 41 receives bet information transmitted from each of the terminals 4. Here, the bet information includes information relating to the amount of bets (number of credits) placed by the player and the player's bet target, or information relating to the type of bet (whether or not the bet operation has been performed using the bet-with-a-bonus button 201) placed by the player. In addition, the received bet information of each terminal 4 is temporarily stored in the RAM 42.

Subsequently, in S4, the CPU 41 transmits, to each of the terminals 4, information relating to the three dice (for example, information about the combination and the total score of the three numbers shown on the three dice such as a combination of “1” “1” “1”), based on the lottery result of the dice lottery processing of S1. Then, in S5, the image 103 of the three dice which have been shaken by the dealer is displayed on the front display 21 as the main screen 101 (see FIG. 12). Here, for the three dices which have been shaken by the dealer, based on the lottery result of the dice lottery processing of S1, the combination of the three numbers shown on the three dice are displayed.

Next, in S6, the CPU 41 compares the combination and the total score of the three numbers shown on the three dice with the player's bet target and determines the win or loss. Since types of the combinations and the total scores in Sic-Bo are well known, their explanation is omitted here.

Subsequently, in S7, the determination result of win or loss of S6 is transmitted to each of the terminals 4. Additionally, in S8, the CPU 41 displays, on the main screen 101 of the front display 21, an announcement image announcing the determination result of win or loss of each of the terminals 4.

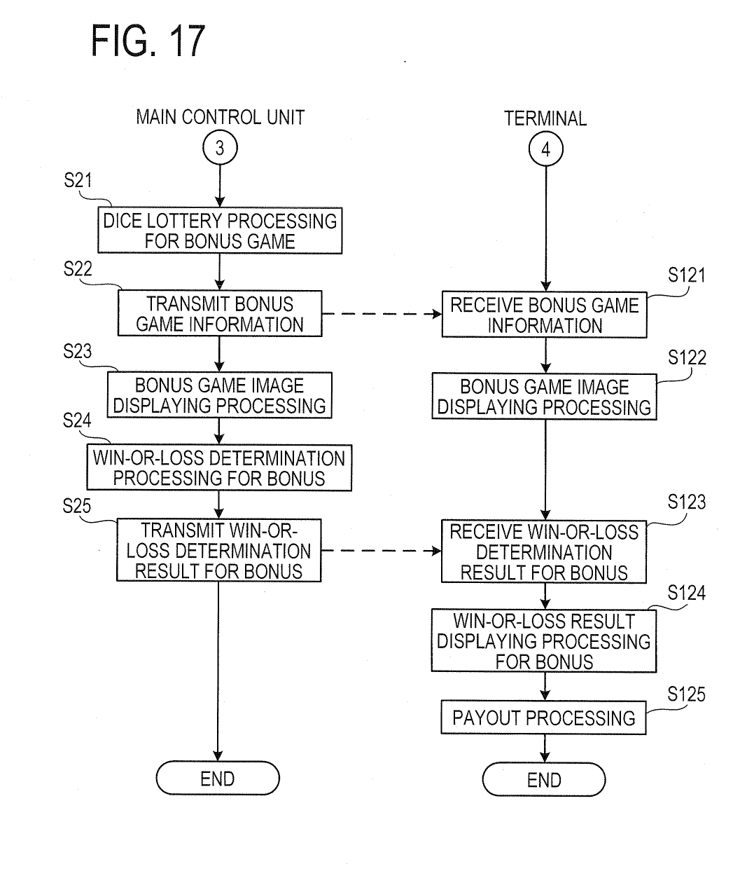

Furthermore, in S9, the CPU 41 determines whether or not a bet-with-a-bonus operation has been performed. The determination is based on the bet information received from each of the terminals 4, and it is determined that a bet-with-a-bonus operation has been performed when a bet has been placed using the bet-with-a-bonus button 201. Here, for a terminal 4 which is determined that no bet-for-a-bonus operation has been performed thereon (S9: NO), the game processing program terminates without doing anything. On the other hand, for a terminal 4 which is determined that a bet-with-a-bonus operation has been performed thereon (S9: YES), the process flow proceeds to a game processing program shown in FIG. 17 described below.

Next, the game processing program executed by the terminal 4 will be described, referring to FIGS. 13 and 14. In S101, the CPU 51 receives the instruction to start the betting period from the main control unit 31.

Subsequently, in S102, the CPU 51 displays the bet screen 70 (see FIGS. 1, 7, 9 and 11) on the liquid crystal display 10, and identifies the player's bet target and the amount of bets (the number of credits) which has been placed, based on operation information from the touch panel 11. In addition, the CPU 51 identifies the type of bet placed by the player (whether or not a bet operation has been performed using the bet-with-a-bonus button 201). Furthermore, the CPU 51 displays the images 72A and 72B of chips on the bet screen 70 in a distinct manner, based on the identified type of bet.

Next, in S103, the CPU 51 determines whether or not the betting period has expired. Specifically, it is determined whether or not a predefined time length (e.g. 20 sec) has passed since accepting the bet operation was started in S102.

If it is determined that the betting period has not expired (S103: NO), accepting the bet operation is continued. If, on the other hand, it is determined that the betting period has expired (S103: YES), the process flow proceeds to S104.

In S104, the CPU 51 transmits the bet information to the main control unit 31. Here, the bet information includes the information relating to the amount of bets (the number of credits) placed by the player and the player's bet target, or the information relating to the type of bet (whether or not the bet operation has been performed using the bet-with-a-bonus button 201) placed by the player.

Additionally, in S105, the CPU 51 receives the information of the three dice (information such as the combination and the total score of the three numbers shown on the three dice) from the main control unit 31. Then, in S106, the CPU 51 displays, on the bet screen 70, the three numbers shown on the three dice are shaking, based on the information of the three dice received in S105. Here, the three dice displayed in S106 are displayed as a series of images from a roll to a stop (see FIG. 11).

Subsequently, in S107, the CPU 51 receives the determination result of win or loss transmitted from the main control unit 31. Then, in S108, the CPU 51 displays, on the liquid crystal display 10, the determination result of win or loss of the player who is playing at the terminal 4, based on the determination result of win or loss received in S107. Specifically, a character string “YOU WON!” is displayed on the win-or-loss display area 95 of the bet screen 70 (see FIG. 11) when the player wins for the bet. Furthermore, a character string “YOU LOST!” is displayed when the player loses for the bet.

Subsequently, in S109, the CPU 51 determines whether or not a bet-with-a-bonus operation has been performed, based on the bet information transmitted in S104.

Here, also in this determination, it is determined that a bet-with-a-bonus operation has been performed when a bet has been placed using the bet-with-a-bonus button 201.

Then, if it is determined that no bet-with-a-bonus operation has been performed (S109: NO), an ordinary payout is made. Specifically, credits multiplied the odds of the player's bet target by the amount of bets (number of credits) which has been placed are paid to the player if the player wins for the bet (S110). Subsequently, the game processing program executed by the CPU 51 of the terminal 4 is terminated.

If, on the other hand, it is determined that a bet-with-a-bonus operation has been performed (S109: YES), payout is made with the amount of the award changed from the case of S110. Specifically, credits 0.7 times the number of credits multiplied the odds of the player's bet target by the amount of bets (number of credits) which has been placed are paid to the player if the player wins for the bet (S111).

Then the process flow proceeds to the game processing program shown in FIG. 17 described below.

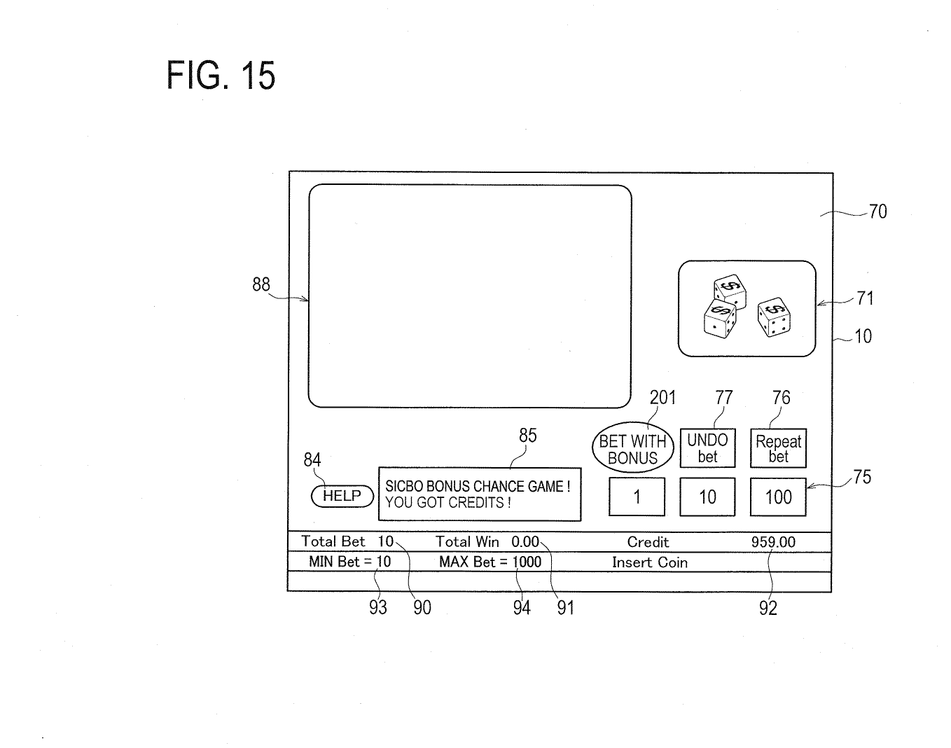

Next, the bet screen 70 displayed on the liquid crystal display 10 of the terminal 4 when executing the bonus game in the dice gaming machine 1 according to the present embodiment will be described, referring to FIGS. 15 and 16. FIGS. 15 and 16 shows the bet screen 70 displayed on the liquid crystal display 10 of the terminal 4 when executing the bonus game. Here, with the dice gaming machine 1 according to the present embodiment, when the bonus game is executed subsequent to Sic-Bo, the three dice, which are shaken again, are displayed on the dice display area 71 of the bet screen 70, as shown in FIGS. 15 and 16. However, in each die, “6” is exchanged with “$”. As shown in FIG. 15, then, if the combination of the three numbers shown on the three dice, which are shaken again, is a winning combination of “$” “$” “$”, the maximum amount of credits is paid to the player. Messages “SICBO BONUS CHANCE GAME! YOU GOT CREDITS!” are displayed on the message area 85 of the bet screen 70. On the other hand, for example, as shown in FIG. 16, if the combination of the three numbers shown on the three dice, which are shaken again, is not a winning combination of “$” “$” “$”, the amount of credits is not paid to the player. Messages “SICBO BONUS GAME! YOU LOST!” are displayed on the message area 85 of the bet screen 70.

Next, with regard to the bonus game which has been executed subsequent to Sic-Bo, a game processing program executed by the CPU 41 of the main control unit 31 and a game processing program at the terminal side executed by the CPU 51 of the terminal 4, respectively, in the dice gaming machine 1 according to the present embodiment will be described, referring to FIG. 17. Here, respective programs shown as a flow chart in FIG. 17 are stored in the RAM 42 or the ROM 43 provided in the main control unit 31, or the RAM 52 or the ROM 53 provided in the terminal 4, and are executed by the CPU 41 or the CPU 51.

First, the game processing program executed by the main control unit 31 will be described, referring to FIG. 17. The main control unit 31 executes the game processing program for the terminal 4 which is determined in S9 of the above-mentioned FIG. 14 that a bet-with-a-bonus operation has been performed thereon (S9: YES). In S21, the CPU 41 executes a dice lottery processing for a bonus game to draw three numbers shown on three dice. Specifically, a number within the range of 1 to 6 is associated with each one of cube's faces composing one of the dice to be used in the bonus game. Each die is marked on each of its six faces with “1”, “2”, “3”, “4”, “5”, and “$”. Then, one number within the range of 1 to 6 is drawn. This drawing is executed about each die respectively. A combination of three numbers shown on the three dice is determined by a combination of the drawn numbers.

Subsequently, in S22, the CPU 41 transmits, to the terminal 4, information relating to the three dice shaken to the player who is playing the bonus game at the terminals 4 (for example, information about the combination of the three numbers shown on the three dice such as a combination of “$” “$” “$”), based on the lottery result of the dice lottery processing for a bonus game of S21.

Then, in S23, the image 103 of the three dice which have been shaken by the dealer is displayed on the front display 21 as the main screen 101 (see FIG. 12). Here, for the three dices which have been shaken by the dealer, based on the lottery result of the dice lottery processing for a bonus of S21, the combination of the three numbers shown on the three dice are displayed.

Next, in S24, the CPU 41 determines the win or loss of bonus game, based on the information transmitted in S22 to the terminal 4 relating to the bonus game. Specifically, the player wins if the combination of the three numbers shown on the three dice is a winning combination of “$”“$”“$”, whereas the player loses if the combination of the three numbers shown on the three dice is not a winning combination of “$” “$” “$”. Then, if the player wins, the maximum amount of credits is awarded to the player at the terminal 4.

Subsequently, in S25, the determination result in S24 of the win or loss for the bonus is transmitted to the terminal 4. If the determination result in S24 of the win or loss for the bonus turns out to be the player's winning, the maximum amount of credits is included in the transmitted data.

In this manner, with regard to the bonus game which has been executed subsequent to Sic-Bo, the game processing program executed by the CPU 41 of the main control unit 31 is terminated.

Next, the game processing program executed by the terminal 4 will be described, referring to FIG. 17. In S121, the CPU 51 receives, from the main control unit 31, the information relating to the three dice shaken at the terminals 4 (for example, information about the combination of the three numbers shown on the three dice such as a combination of “$”“$”“$”). Then, in S122, the CPU 51 displays, on the dice display area 71 of the bet screen 70, the three numbers shown on the three dices are shaking, based on the bonus game information received in S121. Here, the three dice displayed in S122 are displayed as a series of images from a roll to a stop (see FIGS. 15 and 16).

Subsequently, in S123, the CPU 51 receives the determination result of win or loss for the bonus transmitted from the main control unit 31. Then, in S124, the CPU 51 displays, on the liquid crystal display 10, the determination result of win or loss of the player who is playing at the terminal 4, based on the determination result of win or loss transmitted in S123. Specifically, if the player wins in the bonus game, the three dice is displayed as images of rolling and stopping in showing a combination of “$” “$” “$” on the dice display area 71 of the bet screen 70, and a character string “SICBO BONUS CHANCE GAME! YOU GOT CREDITS!” is displayed on the message area 85 of the bet screen 70, as shown in FIG. 15. If, on the other hand, the player loses in the bonus game, the three dice is displayed as images of rolling and stopping in showing a combination except a combination of “$” “$” “$” on the dice display area 71 of the bet screen 70, and a character string “SICBO BONUS CHANCE GAME! YOU LOST!” is displayed on the message area 85 of the bet screen 70, as shown in FIG. 16.

Then, in S125, the CPU 51 executes a payout processing to add and store, in the RAM 53, the maximum amount of credits included as data in the determination result of win or loss received in S123, and provide it to the player.

Here, the maximum amount of credits is an amount of credits multiplied the maximum odds (180 times) by the amount of bets (number of credits).

In this manner, with regard to the bonus game which has been executed subsequent to Sic-Bo, the game processing program executed by the CPU 51 of the terminal 4 is terminated.

Note that the present invention is not limited to the above examples, and various kinds of improvement or modification are possible without deviating from the scope of the present invention.

For example, in the present embodiment, the player wins in the bonus game if the combination of the three numbers shown on the three dice is a combination of “$” “$” “$”, in addition, the player wins in the bonus game if the combination of the three numbers shown on the three dice is a combination of “1” “1” “1”, a combination of “2” “2” “2”, a combination of “3” “3” “3”, a combination of “4” “4” “4”, or a combination of “5” “5” “5”.

Furthermore, the number of credits provided to the player who won in the bonus game may be changed within the range of 100 to 500, instead of the maximum amount of credits. Therefore, it may be arranged such that, for example, the main control unit 31 acquires, by lottery, a number of credits and includes the number of credits acquired into the determination result in S25 of the win or loss for the bonus. The lottery may be executed either by hardware or software.

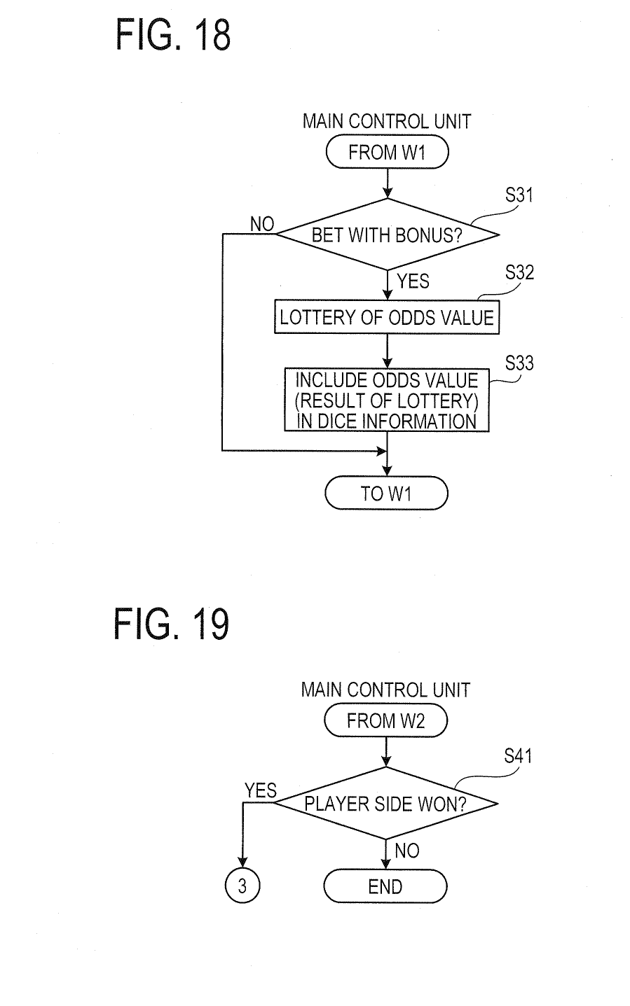

Additionally, in Sic-Bo with the present embodiment, when the player indicates the amount of bets using the bet-with-a-bonus button 201, the odds for which may be changed (it is fixed at an ordinary value x0.7 in the above example). Therefore, it may be arranged such that, for example, the main control unit 31 executes a game processing program shown in FIG. 18 at a time point W1 located in the middle between S3 and S4 of the game processing program shown in FIG. 13. In other words, when the bet information is received by S3 of the game processing program shown in FIG. 13, the process flow proceeds to S31 of the game processing program shown in FIG. 18 where the CPU 41 of the main control unit 31 determines whether or not a bet-with-a-bonus operation has been performed. This determination is based on the bet information received from each of the terminals 4, and it is determined that a bet-with-a bonus operation has been performed if a bet operation has been performed using the bet-with-a-bonus button 201. Here, for a terminal 4 which is determined that no bet-for-a-bonus operation has been performed thereon (S31: NO), the process flow returns to the game processing program shown in FIG. 13 and proceeds to S4 without doing anything. On the other hand, for a terminal 4 which is determined that a bet-with-a-bonus operation has been performed thereon (S31: YES), the process flow proceeds to S32.

In S32, the CPU 41 acquires, by lottery, a numerical formula within the range of x0.1 to x1.0. The lottery may be executed either by hardware or software. Subsequently, in S33, the CPU 41 includes the numerical formula acquired in S32 into the dice information (see S4 of FIG. 13), then the process flow returns to the game processing program shown in FIG. 13 and proceeds to S4.

In this manner, when the main control unit 31 executes the game processing program shown in FIG. 18, the CPU 51 of each of the terminals 4 displays, in S106 of the game processing program shown in FIG. 13, the numerical formula included in the dice information on the message area 85 of the bet screen 70. For example, if the numerical formula included in the dice information is x0.5, a character string “BET WITH BONUS IS INDICATED! YOUR ODDS LOWER WITH x0.7x0.5. YOU WILL HAVE A BONUS GAME!” is displayed on the message area 85 of the bet screen 70. Furthermore, when the process flow proceeds to S111 of the game processing program shown in FIG. 14, the CPU 51 of each of the terminals 4 executes payout of an award based on the numerical formula included in the dice information.

In addition, the present embodiment may be limited such that the bonus game executed subsequent to Sic-Bo is executed only if the player side wins for the player's bet in Sic-Bo.

Therefore, it may be arranged such that, for example, the main control unit 31 executes a game processing program shown in FIG. 19 at a time point W2 located in the middle between S9 of the game processing program shown in FIG. 14 and S21 of the game processing program shown in FIG. 17. In other words, for the terminal 4 which is determined, in S9 of the game processing program shown in FIG. 14, that a bet-with-a-bonus operation has been performed thereon (S9: YES), the process flow proceeds to S41 of FIG. 19 where the CPU 41 determines whether or not the player side has won for the player's bet in Sic-Bo at the terminal 4. The determination is based on the determination result of win or loss in S7 of the game processing program shown in FIG. 14. Here, if it is determined that the player side has won for the player's bet in Sic-Bo of the terminal 4 (S41: YES), the process flow proceeds to S21 of the game processing program shown in FIG. 17, and the CPU 41 executes the bonus game at the terminal 4. If, on the other hand, it is determined that the player side has not won (defeat) for the player's bet in Sic-Bo at the terminal 4 (S41: NO), the main control unit 31 subsequently terminates the game processing program.

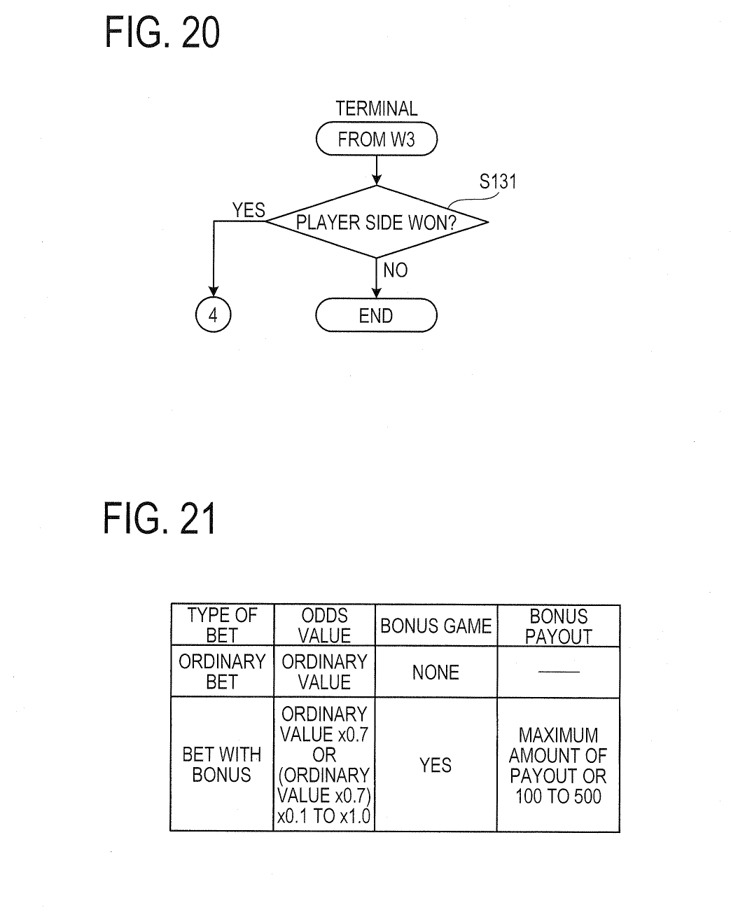

Furthermore, it may be arranged such that, for example, each of the terminals 4 executes a game processing program shown in FIG. 20 at a time point W3 located in the middle between S111 of the game processing program shown in FIG. 14 and S121 of the game processing program shown in FIG. 17. In other words, for the terminal 4 which is determined, in S109 of the game processing program shown in FIG. 14, that a bet-with-a-bonus operation has been performed thereon (S109: YES), the process flow proceeds to S131 of FIG. 20 via the reduced payout processing of S111, where the CPU 51 determines whether or not the player side has won for the player's bet in Sic-Bo at the terminal 4. The determination is based on the determination result of win or loss received in S108 of the game processing program shown in FIG. 14. Here, if it is determined that the player side has won for the player's bet in Sic-Bo of the terminal 4 (S131: YES), the process flow proceeds to S121 of the game processing program shown in FIG. 17, and the CPU 41 executes the bonus game. If, on the other hand, it is determined that the player side has not won (defeat) for the player's bet in Sic-Bo at the terminal 4 (S131: NO), the game processing program executed by the terminal 4 is subsequently terminated.

In this manner, if the main control unit 31 executes the game processing program shown in FIG. 19 and if each of the terminals 4 executes the game processing program shown in FIG. 20, the bonus game executed subsequent to Sic-Bo is executed only on the terminal 4 at which the player side won in Sic-Bo.

Additionally, with the present embodiment, the dice gaming machine 1 which executes Sic-Bo and the bonus game may be a gaming machine on which the above-mentioned control unit 31 and the terminal 4 are integrated.

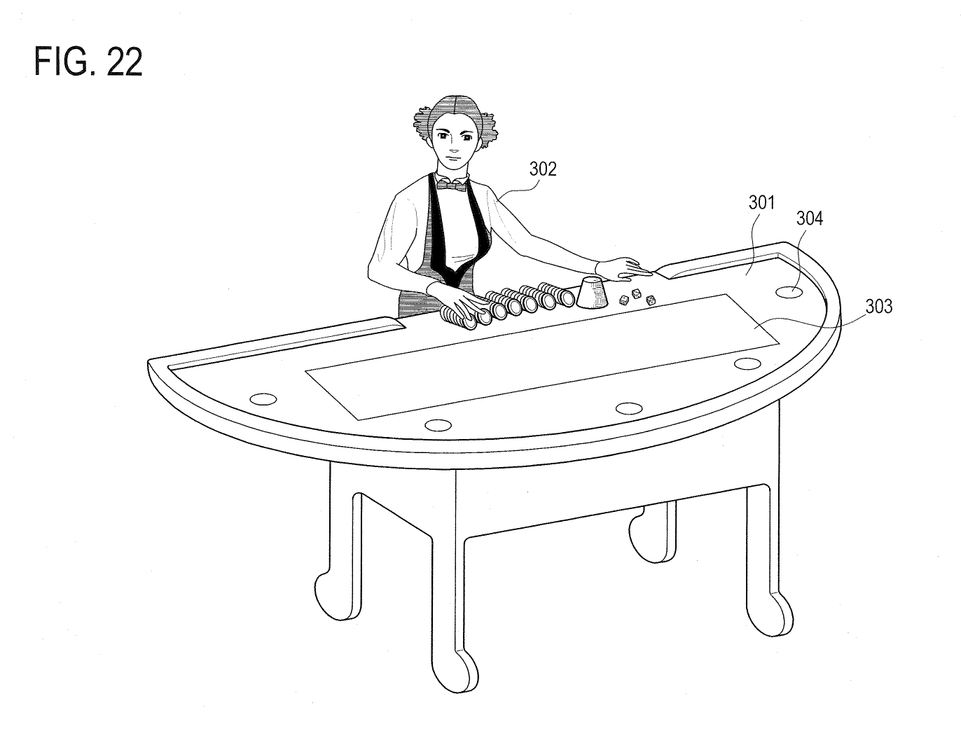

In addition, the playing method of the dice game according to the present invention can also be applied to Sic-Bo (so-called table game) played by the dealer 302 and the player (not shown) on a gaming table 301, as shown in FIG. 22.

In the table game shown in FIG. 22, the dealer 302 prepares three dice for the main game and a basket when playing Sic-Bo and, on the gaming table 301, shakes the three dice for the main game in the basket. The player places a bet by putting chips on a betting board 303 of the gaming table 301. In this occasion, if chips are further put on a particular spot 304 adjacent to the betting board 303, the dealer 302 determines that a bet-with-a-bonus operation has been performed. However, the dealer 302 may also determine that a bet-with-a-bonus operation has been performed if special chips are put on the betting board 303.

In addition, the dealer 302 takes three dice for the bonus game when playing the bonus game, shakes the three dice for the bonus game in the basket.

Here, the actual game playing method is similar to that of the dice gaming machine 1 except that the dealer 302 performs shakes the three dice for the main game or the three dice for the bonus game directly.

As described above, with the dice gaming machine 1 and playing method of the dice game according to the present embodiment, there are an ordinary bet operation using only the bet button 75 without using the bet-with-a-bonus button 201, and a bet-with-a-bonus operation using both the bet-with-a-bonus button 201 and the bet button 75, as the bet operation of Sic-Bo. In this regard, FIG. 21 is a table showing the difference between the ordinary bet operation and the bet-with-a-bonus operation.

If an ordinary bet operation is performed in Sic-Bo, the odds value is the ordinary value (different in every bet spots of combinations or total sores of the three number shown on the three dice) fixed and no bonus game will be executed subsequent to Sic-Bo, as shown in FIG. 21.

If, on the other hand, a bet-with-a-bonus operation is performed in Sic-Bo, the odds value is fixed to the ordinary value x0.7 or varied within the range of the ordinary value x0.7 x0.1 to the ordinary value x0.7 x1.0. However, the ordinary value is different in every bet spots of combinations or total sores of the three numbers shown on the three dice. Furthermore, the bonus game is executed subsequent to Sic-Bo, and a variable number of 100 to 500 credits or a fixed maximum amount of payout will be awarded as a bonus payout to the winner of the bonus game. Here, an additional condition such that the player has to win for the player's bet in Sic-Bo may be posed in order to execute the bonus game subsequent to Sic-Bo.

What is claimed is:

1. A gaming machine comprising:
a display device for displaying three dice used in a main game;
an operation unit for allowing a player to indicate the number of bets of one of a first type and a second type for any of a plurality of bet spots;
a memory for storing the number of credits held by the player; and
a processor programmed to execute the main game by executing processes of:
when the number of bets of the first type is indicated by an operation on the operation unit,
(a) displaying, upon completion of the player's performing the operation of indicating the number of bets using the operation unit, a new outcome of shaking the three dice on the display device;
(b) determining whether or not the player side wins, based on a combination of numbers shown on the three dice which have been displayed on the display device; and
(c) if it is determined that the player side wins, adding the number of credits calculated using a predefined odds to the number of credits in the memory and storing the sum,
when, otherwise, the number of bets of the second type is indicated by an operation on the operation unit,
(d) changing the odds to a lower value than the predefined odds and executing the main game;
(e) randomly determining whether or not to award a bonus to the player; and
(f) if it is determined to award the bonus to the player, adding the number of credits according to the bonus to the number of credits in the memory and storing the sum.

2. The gaming machine according to claim 1, wherein
the processor is programmed to randomly determine whether or not to award the bonus to the player by executing processes of:
(a) displaying a new outcome of shaking again the three dice on the display device; and
(b) if the new outcome of shaking again the three dice, which have been displayed on the display device, is a combination of all same numbers, determining to award the bonus to the player.

3. The gaming machine according to claim 1, wherein
the processor is programmed to randomly determine whether or not to award the bonus to the player by executing processes of:
(a) displaying a new outcome of shaking again the three dice on the display device; and
(b) if the new outcome of shaking again the three dice, which have been displayed on the display device, is a combination of all same numbers, determining to award the bonus to the player,
furthermore, the processor is programmed to execute processes of:
(a′) using new three dice, respectively, marked on only one face with a predefined mark as the three dice; and
(b′) if a new outcome of shaking the new three dice, which have been displayed on the display device, is a combination of all the predefined mark, determining to award the number of credits according to the bonus to the player as the maximum amount of credits.

4. The gaming machine according to claim 1, wherein
the processor is programmed to randomly determine whether or not to award the bonus to the player by executing processes of:
(a) separately from the main game, determining to award the bonus to the player.

5. A game playing method comprising, so as to make a main game proceed, the steps of: when a player indicates the number of bets of a first type for any of a plurality of bet spots,
(a) getting, upon completion of the player's indicating the number of bets, a new outcome of shaking the three dice;
(b) determining whether or not the player side wins, based on a combination of numbers shown on the three dice; and
(c) if it is determined that the player side wins, the number of credits calculated using a predefined odds are awarded to the player;
when, otherwise, the player indicates the number of bets of a second type for any of the bet spots,
(d) changing the odds to a lower value than the predefined odds and executing the main game;
(e) randomly determining whether or not to award a bonus to the player; and
(f) if it is determined to award the bonus to the player, awarding the number of credits according to the bonus to the player.

6. The game playing method according to claim 5 comprising the steps of: so as to randomly determine whether or not to award the bonus to the player,
(a) getting a new outcome of shaking again the three dice; and
(b) if the new outcome of shaking again the three dice is a combination of all same numbers, determining to award the bonus to the player.

7. The game playing method according to claim 5 comprising the steps of: so as to randomly determine whether or not to award the bonus to the player,
(a) getting a new outcome of shaking again the three dice; and
(b) if the new outcome of shaking again the three dice is a combination of all same numbers, determining to award the bonus to the player,
furthermore, comprising the steps of:
(a′) using new three dice, respectively, marked on only one face with a predefined mark as the three dice; and
(b′) if a new outcome of shaking the new three dice is a combination of all the predefined mark, determining to award the number of credits according to the bonus to the player as the maximum amount of credits.

8. The game playing method according to claim 5 comprising the steps of: so as to randomly determine whether or not to award the bonus to the player,
(a) separately from the main game, determining to award the bonus to the player.
